(19) United States
(12) Patent Application Publication
(10) Pub. No.: US 2024/0124031 A1
(43) Pub. Date: Apr. 18, 2024

(54) CONTROL METHOD FOR SAFE TRANSITION TO MANUAL DRIVING MODE IN AUTONOMOUS VEHICLE

(71) Applicants: Hyundai Motor Company, Seoul (KR); Kia Corporation, Seoul (KR)

(72) Inventors: In Su KIM, Anyang-Si (KR); Myung Ki Yeom, Incheon (KR)

(73) Assignees: Hyundai Motor Company, Seoul (KR); Kia Corporation, Seoul (KR)

(21) Appl. No.: 18/124,379

(22) Filed: Mar. 21, 2023

(30) Foreign Application Priority Data
Oct. 18, 2022 (KR) 10-2022-0133660

(51) Int. Cl. B60W 60/00; B60W 30/18; B60W 50/14

(52) U.S. Cl. CPC B60W 60/0051; B60W 30/18163; B60W 50/14; B60W 60/0015; B60W 2050/143; B60W 2050/146; B60W 2554/80

(57) ABSTRACT

When there is a request of a driver for transition to manual driving mode while the autonomous vehicle is driving in autonomous driving mode, the autonomous vehicle is set to a safe state by performing control operations of maintaining a vehicle speed previously designated by the driver, maintaining safe distances between vehicles, and changing the driving land and the driving route. The driver is provided with a warning signal notifying that safe transition to the manual driving mode is possible. Accordingly, the driving mode of the autonomous vehicle is transited to the manual mode in a state in which the safety of the autonomous vehicle is obtained.

### CROSS REFERENCE TO RELATED APPLICATION

The present application claims priority to Korean Patent Application No. 10-2022-0133660, filed Oct. 18, 2022, the entire contents of which is incorporated herein for all purposes by this reference.

### BACKGROUND OF THE PRESENT DISCLOSURE

### Field of the Present Disclosure

The present disclosure relates to a control method for safe transition to manual driving mode in an autonomous vehicle, and more particularly, to a control method for safe transition to manual driving mode in an autonomous vehicle, wherein, when a request for transition to manual driving mode is input by a driver, the transition to manual driving mode may be performed after the vehicle is set to a safe condition.

### Description of Related Art

Driving modes of an autonomous vehicle include an autonomous driving mode in which the vehicle may travel to a destination by itself without requiring a driver to directly operate the steering wheel, the accelerator pedal, the brake pedal, or the like and a manual driving mode in which the driver may intervene in driving of the vehicle.

In general, the driving mode of the autonomous vehicle may be selected from the autonomous driving mode enabled by control of an automatic driving controller and the manual driving mode enabled by driving operation of the driver according to the intention of the driver to select the driving mode. When the driving mode of the autonomous vehicle is transited from the autonomous driving mode to the manual driving mode, there is a transition section of a predetermined time period for obtaining the stability of driving mode transition control.

Generally, when the driving mode of the autonomous vehicle is transited from the autonomous driving mode to the manual driving mode in response to a driver's request, transition to a driver's requested manual driving mode may be performed without changing driving conditions and state of the vehicle, leading to an accident.

For example, in a transition section in which an autonomous vehicle driving in the autonomous driving mode is transited to the manual driving mode, when a manual driving intervention, such as operating the steering wheel, is unintentionally performed by the driver during a high-speed state, the vehicle may be abruptly unstable due to a change in yaw rate. Furthermore, the vehicle may deviate from the driving route, leading to a risk of colliding with an obstacle or a surrounding vehicle.

Accordingly, a method able to stably perform the transition of the autonomous vehicle from the autonomous driving mode to the manual driving mode is demanded.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a control method for safe transition to manual driving mode in an autonomous vehicle. When there is a request of a driver for transition to manual driving mode while the vehicle is driving in autonomous driving mode, the vehicle may be set to a safe state by performing control operations of maintaining a vehicle speed previously designated by the driver, maintaining safe distances between vehicles, and changing the driving land and the driving route, and the driver may be provided with a warning signal notifying that safe transition to the manual driving mode is possible. Accordingly, the driving mode of the vehicle may be transited to the manual mode in a state in which the safety of the vehicle is obtained.

In various aspects of the present disclosure, there is provided a control method for safe transition to manual driving mode in an autonomous vehicle. The control method may include: setting, by an autonomous driving controller, setting conditions for transition to the manual driving mode; determining, by the autonomous driving controller, whether there is a request of a driver for the transition to the manual driving mode; when there is the request of the driver for the transition to the manual driving mode, determining, by the autonomous driving controller, whether an vehicle is driving and whether the vehicle is driving straight; when the vehicle is driving straight, controlling, by the autonomous driving controller, a current speed of the vehicle as a driving speed set by the driver which is one of the setting conditions for transition to the manual driving mode; determining, by the autonomous driving controller, whether the vehicle is in a state in which safe transition to the manual driving mode is possible; notifying, by the autonomous driving controller, that the vehicle is in the state in which the safe transition to the manual driving mode is possible; and after the notification is performed for a first predetermined time period, transiting, by the autonomous driving controller, driving mode of the vehicle to the manual driving mode.

The setting conditions for transition to the manual driving mode may include a driving speed set by the driver of the vehicle desired by a driver in the transition to the manual driving mode and whether to activate an operation of a smart cruise control device after the transition to the manual driving mode.

The control method may further include determining, by the autonomous driving controller, whether the setting conditions for transition to the manual driving mode are changed before the request for the transition to the manual driving mode is accomplished.

Furthermore, when the vehicle is determined to be turning as a result of the determining of whether the vehicle is driving straight, the control method may further include determining, by the autonomous driving controller, whether the vehicle is able to drive straight within a second predetermined time period. When the vehicle is determined to not be able to drive straight within the second predetermined time period, the control method may further include notifying, by the autonomous driving controller, the driver that the transition to the manual driving mode is not possible and maintaining the driving mode as the autonomous driving mode of the vehicle.

In the determining of whether the vehicle is in the state in which the safe transition to the manual driving mode is possible, determining whether the vehicle has obtained safe distances from vehicles driving ahead and behind the vehicle and whether the driving speed set by the driver is maintained may be performed first.

Thus, when the vehicle is determined to have obtained the safe distances from the vehicles driving ahead and behind the vehicle and the driving speed set by the driver is determined to be maintained, a driver may be notified that the vehicle is in the state in which the safe transition to the manual driving mode is possible.

Furthermore, when the vehicle is determined to not be able to obtain the safe distances from the vehicles driving ahead and behind the vehicle, the determining of whether the vehicle is in the state in which the safe transition to the manual driving mode is possible may include determining whether the vehicle is able to obtain safe distances from vehicles driving ahead and behind the vehicle by changing a current driving lane of the vehicle to another driving lane.

Thus, when the vehicle is determined to be able to obtain safe distances from vehicles driving ahead and behind the vehicle by changing the current driving lane to another driving lane, a driver may be notified that the vehicle is in the state in which the safe transition to the manual driving mode is possible.

When the vehicle is determined to be being parked or stopped instead of being driving as a result of the determining of whether the vehicle is driving, the vehicle may be determined to be in the state in which the safe transition to the manual driving mode is possible, and a driver may be notified that the vehicle is in the state in which the safe transition to the manual driving mode is possible.

After notifying that the vehicle is in the state in which the safe transition to the manual driving mode is possible, the control method may further include determining, by the autonomous driving controller, whether the driver has canceled the request for the transition to the manual driving mode within a third predetermined time period.

Thus, when the driver has canceled the request for the transition to the manual driving mode within the third predetermined time period, the control method may further include notifying, by the autonomous driving controller, the driver that the transition to the manual driving mode is not possible and maintaining the driving mode of the vehicle as the autonomous driving mode of the vehicle.

In contrast, when the driver has not canceled the request for the transition to the manual driving mode within the third predetermined time period, the transition of the driving mode of the vehicle to the manual driving mode may be performed by the autonomous driving controller.

When a request to activate an operation of a smart cruise control device is determined to have been input as the setting conditions for transition to the manual driving mode after the transition of the driving mode of the vehicle to the manual driving mode by the autonomous driving controller, the control method may further include activating the operation of the smart cruise control device.

Furthermore, when the controller concludes that the vehicle cannot obtain the safe distances from the vehicles driving ahead and behind the vehicle by changing the current driving lane to another driving lane, the control method may further include guiding the driver to select another safe position in the current driving route of the vehicle or a safe position in another driving route using a warning signal.

When the driver has not selected another safe position in the current driving route or the safe position in another driving route, the control method may further include notifying, by the autonomous driving controller, the driver that the transition to the manual driving mode is not possible and maintaining the driving mode of the vehicle as the autonomous driving mode of the vehicle.

In contrast, the control method may further include, when the driver has selected another safe position in the current driving route or another safe position in another driving route, controlling, by the autonomous driving controller, the vehicle to move to the position selected by the driver.

After the vehicle has moved to the selected position, the control method may return to the determining of whether the vehicle is driving and whether the vehicle is driving straight by the autonomous driving controller.

According to an exemplary embodiment of the present disclosure, the following effects are provided.

First, when there is a request of a driver for transition to manual driving mode, the vehicle may be set to a safe state with no risk of colliding with surrounding vehicles by performing control operations of maintaining a vehicle speed previously designated by the driver, maintaining safe distances between vehicles, and changing the driving land and the driving route, so that the request of the driver for transition to manual driving mode may be safely performed in a state in which the safety of the vehicle is obtained.

Second, when there is a request of a driver for transition to manual driving mode, the vehicle may be set to a safe state with no risk of colliding with surrounding vehicles and then the driver may be provided with a warning signal notifying that safe transition to the manual driving mode is possible, providing the driver with stability and convenience in the transition to the manual driving mode.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 and FIG. 2 are configuration diagrams illustrating a control method for safe transition to manual driving mode in an autonomous vehicle according to an exemplary embodiment of the present disclosure; and

FIG. 3 and FIG. 4 are flowcharts illustrating the control method for safe transition to manual driving mode in an autonomous vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION OF THE PRESENT DISCLOSURE

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

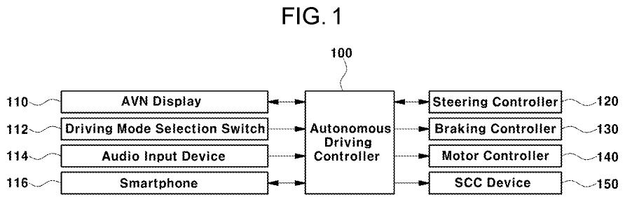

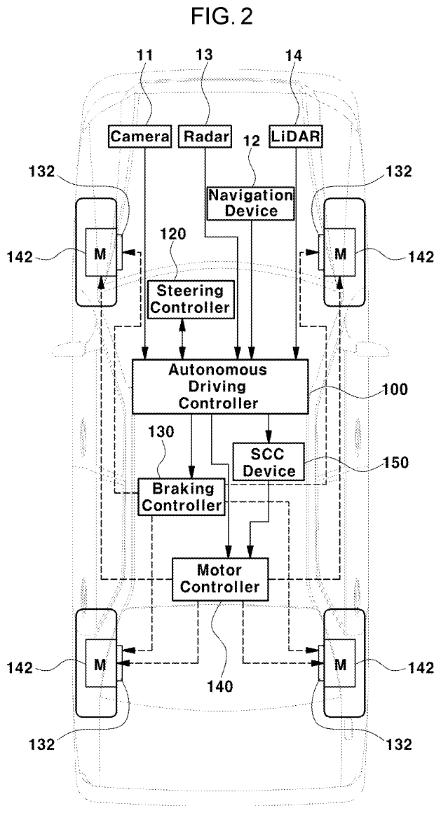

In the accompanying drawings, FIG. 1 and FIG. 2 are configuration diagrams illustrating a control method for safe transition to manual driving mode in an autonomous vehicle according to an exemplary embodiment of the present disclosure.

As illustrated in FIG. 1, an autonomous vehicle is provided with an autonomous driving controller 100 for overall autonomous driving control. An audio, video, and navigation (AVN) display 110, a driving mode selection switch 112, and an audio input device 114 are connected to an input portion of the autonomous driving controller 100 so that electric signals may be transmitted and received therebetween. Furthermore, a smartphone 116 possessed by a driver may also be connected to the input portion of the autonomous driving controller 100 in a communicable manner.

A steering controller 120 for steering control and a braking controller 130 and a motor controller 140 for driving control, such as acceleration control and deceleration control, are connected to an output portion of the autonomous driving controller 100 so that electric signals may be transmitted and received therebetween.

Furthermore, a smart cruise control (SCC) device 150 for adjusting the speed of the vehicle at a predetermined speed and maintaining a distance from a vehicle driving ahead the autonomous vehicle at a safe distance is connected to the output portion of the autonomous driving controller 100 so that electric signals may be transmitted and received therebetween.

For reference, the SCC device 150 refers to a driving convenience device configured to automatically decelerate the speed of the vehicle when a distance from a vehicle driving ahead is less than a predetermined safe distance and accelerate the speed of the vehicle to a predetermined speed when the distance from the vehicle driving ahead is equal to or greater than the predetermined safe distance.

Thus, the driver may input setting conditions for transition to the manual driving mode by manipulating a corresponding menu displayed on the Audio, Video and Navigation (AVN) display 110 manually, input setting conditions for transition to the manual driving mode through the audio input device 114, or input setting conditions for transition to the manual driving mode by manipulating a dedicated application provided in the smartphone 116. Such setting conditions for transition to the manual driving mode input in the present manner may be transmitted to the autonomous driving controller 100 and stored in a memory of the autonomous driving controller 100.

Here, the setting conditions for transition to the manual driving mode include a driving speed set by the driver desired by the driver in case of transition to the manual driving mode (i.e., a driving speed set by the driver for safe transition to the manual driving mode), whether or not the SSC device is operated after transition to the manual driving mode, and the like.

Furthermore, the driver may input a request for transition to the autonomous driving mode or the manual driving mode by manipulating the corresponding menu displayed on the AVN display 110, by operating a driving mode selection switch 112, using the audio input device 114, or by operating a dedicated application of the smartphone 116. A signal of the request for transition to the autonomous driving mode or the manual driving mode may be transmitted to the autonomous driving controller 100.

As illustrated in FIG. 2, the autonomous driving controller 100 is configured to receive various types of monitoring information necessary for autonomous driving from a detector for autonomous driving (or an autonomous driving detector), such as a camera 11, a navigation device 12, a radio detection and ranging (radar) 13, and a light imaging detection and ranging (LiDAR) 14, mounted on the vehicle, and perform overall control over the driving direction, acceleration, deceleration, and the like of the vehicle based on such information.

The steering controller 120 is configured to control steering according to a steering intention in response to an autonomous driving of the autonomous driving controller 100 or a steering intention in response to a driver's operation of the steering wheel.

The braking controller 130 is configured to control application of hydraulic braking torque to hydraulic braking devices 132 mounted on the wheels, respectively, according to a hydraulic braking torque command.

The braking controller 130 may be an integrated electric brake (IEB) controller including an electronic stability control (ESC) for position control of the vehicle body.

The motor controller 140 is configured to control drive torque and control regenerative braking torque with respect to in-wheel motors (IWMs) 142 mounted on the wheels, respectively. The motor controller 140 is configured to perform a control operation of applying the regenerative braking torque and/or the drive torque to each of the in-wheel motors 142 mounted on the wheels according to a drive torque command or a regenerative braking torque command.

When there is a request for transition to the manual driving mode in the autonomous driving mode, autonomous driving controller 100 may perform a control operation of adjusting the speed of the vehicle to a driver set driving speed (i.e., a driving speed set by the driver for safe transition to the manual driving mode) desired by the driver to set the autonomous vehicle in a safe state (in which the autonomous vehicle is in a safe distance not influenced by a surrounding vehicle, an obstacle, or the like) according to the setting conditions for transition to the manual driving mode, i.e., to set the vehicle in a state in which transition to the manual driving mode may be safely performed, and at the same time, perform control operations of maintaining safe distances from vehicles driving ahead and behind the autonomous vehicle, changing a driving lane and a driving route, and the like.

Furthermore, after the autonomous vehicle is set to the state in which the transition to the manual driving mode may be safely performed, and at the same time, i.e., in the safe state in which the autonomous vehicle is not influenced by a surrounding vehicle, an obstacle, or the like, according to the setting conditions for transition to the manual driving mode, the autonomous driving controller 100 may notify the driver that the current driving mode may be transited to the manual driving mode.

Furthermore, when there is no driver's intention to cancel the request for transition to the manual driving mode within a predetermined time after notifying the driver that the current driving mode may be transited to the manual driving mode, the autonomous driving controller 100 may perform a control operation of transiting the driving mode of the autonomous vehicle to the manual driving mode.

Furthermore, after the driving mode is transited to the manual driving mode, when a request to operate the SCC device 150 is input as the setting conditions for transition to the manual driving mode, the autonomous driving controller 100 may perform a control operation of activating the operation of the SCC device 150.

Furthermore, when the vehicle is determined to be turning instead of driving straight based on a steering angle signal of the steering controller 120 or when a driver's intention to cancel the request of the driver for transition to the manual driving mode is reviewed within a predetermined time after the driver is notified that the driving mode may be transited to the manual driving mode, the autonomous driving controller 100 may notify the driver that the transition to the manual driving mode is not possible and perform a control operation of maintaining the driving mode as the autonomous driving mode of the vehicle.

Furthermore, even in the case that the control operation of maintaining the speed of the vehicle at the driving speed set by the driver desired by the driver (i.e., the driving speed set by the driver for safe transition to the manual driving mode) is performed and the control operations of maintaining safe distances from vehicles driving ahead and behind the autonomous vehicle, changing a driving lane and a driving route, and the like are performed, when the autonomous vehicle cannot be set to a safe condition in which the transition to the manual driving mode may not be safely performed, the autonomous driving controller 100 may notify the driver that the transition to the manual driving mode is not possible and perform a control operation of maintaining the driving mode as the autonomous driving mode of the vehicle.

Hereinafter, a control method for safe transition to the manual driving mode in the autonomous vehicle based on the above-described configuration according to an exemplary embodiment of the present disclosure will be sequentially referred to as follows.

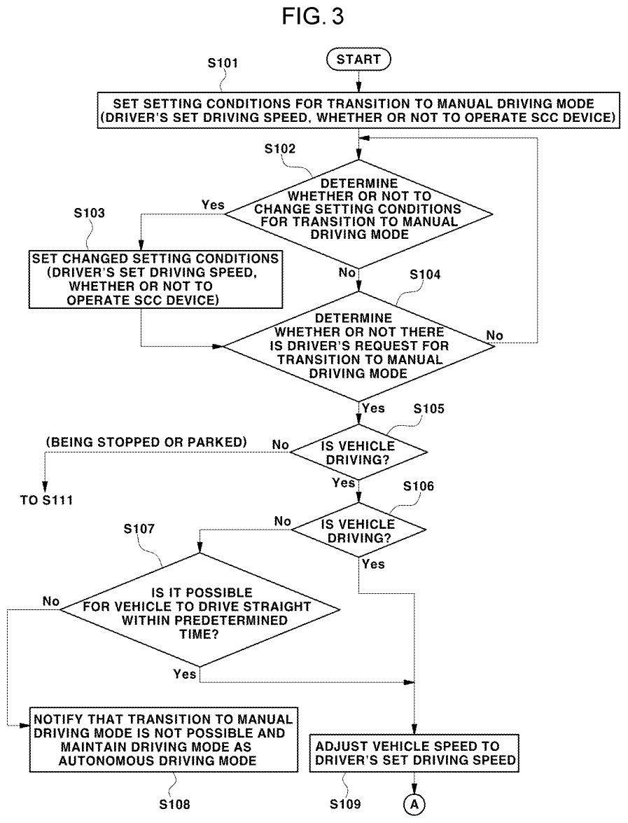

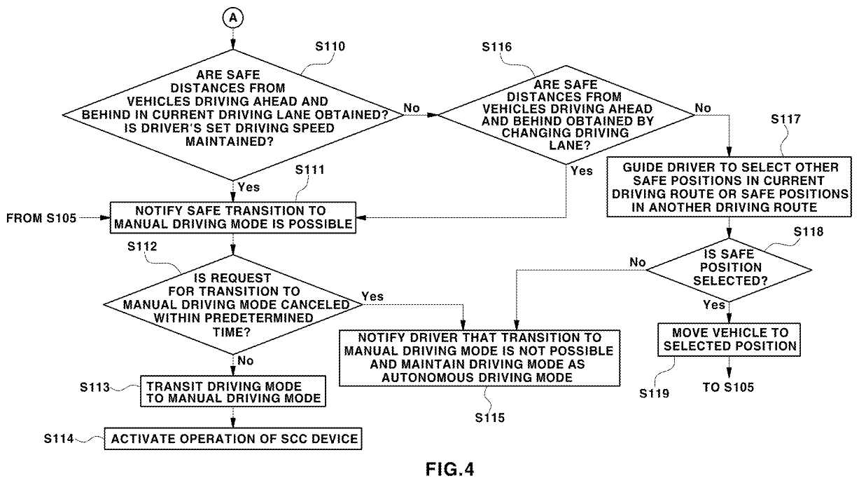

In the accompanying drawings, FIG. 3 and FIG. 4 are flowcharts illustrating the control method for safe transition to manual driving mode in an autonomous vehicle according to an exemplary embodiment of the present disclosure.

First, when the autonomous vehicle is started (ON), the autonomous driving controller 100 sets setting conditions for transition to the manual driving mode in S101.

The setting conditions for transition to the manual driving mode may be conditions previously set by the driver or initial setting conditions, which are stored in the memory of the autonomous driving controller 100.

The setting conditions for transition to the manual driving mode may include the driving speed set by the driver of the vehicle desired by the driver (i.e., the driving speed set by the driver for safe transition to the manual driving mode) in the transition to the manual driving mode and whether or not to operate the SCC device after the transition to the manual driving mode. The driver may also input a variety of other conditions for transition to the manual driving mode manually.

For example, the setting conditions for transition to the manual driving mode may be input by the driver manually by manipulating the corresponding menu displayed on the AVN display 110, using the audio input device 114, or by manipulating the dedicated application of the smartphone 116 possessed by the driver. The setting conditions for transition to the manual driving mode input in the present manner may be transmitted to autonomous driving controller 100 and stored in the memory of the autonomous driving controller 100.

Thus, when the autonomous vehicle is started (ON), the autonomous driving controller 100 may set the setting conditions for transition to the manual driving mode recorded in the memory.

In sub sequence, whether or not to change the setting conditions for transition to the manual driving mode is determined in S102.

Whether or not to change the setting conditions for transition to the manual driving mode is determined because the driver may change the setting conditions for transition to the manual driving mode before the request of the driver for transition to the manual driving mode is accomplished after the autonomous vehicle is started (ON).

At the present time, when the driver input new setting conditions for transition to the manual driving mode using the AVN display 110, the audio input device 114, the smartphone 116, or the like, the new setting conditions may be stored in the memory of the autonomous driving controller 100.

Accordingly, the autonomous driving controller 100 may easily determine whether or not to change the setting conditions for transition to the manual driving mode and set the changed setting conditions (e.g., the driving speed set by the driver of the vehicle, whether or not to operate the SCC device, etc.) again in S103.

When the driver does not change the setting conditions for transition to the manual driving mode, when the vehicle is turned off, the setting conditions for transition to the manual driving mode stored in the memory of the autonomous driving controller 100 may be set to initial values.

As described above, the autonomous driving controller 100 may set the setting conditions for transition to the manual driving mode in step S101 before the driver′ request for transition to the manual driving mode after the vehicle is started or set the setting conditions for transition to the manual driving mode in step S103 after determining whether or not to change the setting conditions for transition to the manual driving mode in step S102.

Afterwards, the autonomous driving controller 100 is configured to determine whether or not there is the request of the driver for transition to the manual driving mode while the autonomous vehicle is driving in the autonomous driving mode in S104.

For example, the driver may input the request for transition to the manual driving mode by manipulating the corresponding menu displayed on the AVN display 110, by operating the driving mode selection switch 112, using the audio input device 114, or by operating the dedicated application of the smartphone 116. A signal of the request for transition to the autonomous driving mode may be transmitted to the autonomous driving controller 100, which in turn may review the request for transition to the autonomous driving mode of the vehicle.

When there is no request for transition to the manual driving mode, the autonomous driving controller 100 maintains the driving mode of the autonomous vehicle as the autonomous driving mode of the vehicle.

In sub sequence, the autonomous driving controller 100 reviews whether or not the vehicle is driving in S105.

For example, the autonomous driving controller 100 may be configured to determine whether the vehicle is driving or is being parked or stopped based on a detection signal from a vehicle speed detector.

In subsequence, when the vehicle is determined to be driving instead of being parked or stopped as the result of step S105, the autonomous driving controller 100 is configured to determine whether or not the vehicle is driving straight in S106.

For example, the autonomous driving controller 100 may be configured to determine whether the vehicle is turning or is driving straight by receiving a steering angle signal from the steering controller 120.

When the vehicle is turning as the result of step S106, the autonomous driving controller 100 is configured to determine whether or not it is possible for the vehicle to drive straight within a predetermined time period in S107.

For example, the autonomous driving controller 100 may be configured to determine whether or not it is possible for the vehicle to drive straight by stopping turning within the predetermined time period based on navigation information.

When it is determined to not be possible for the vehicle to drive straight within the predetermined time period since turning will continue for the predetermined time period or longer as the result of step S107, the autonomous driving controller 100 performs a warning operation of notifying the driver that the transition to the manual driving mode is not possible and a control operation of maintaining the driving mode as the autonomous driving mode in S108.

For example, the autonomous driving controller is configured to perform the warning operation of visually notifying the driver that the transition to the manual driving mode is not possible using the AVN display 110 or notifying the driver that the transition to the manual driving mode is not possible using the audio input device 114 and also performs the control operation of maintaining the driving mode as the autonomous driving mode of the vehicle.

Afterwards, the autonomous driving controller 100 is configured to determine whether or not safe transition to the manual driving mode is possible.

That is, the autonomous driving controller 100 is configured to determine whether or not the vehicle is being maintained at the driving speed set by the driver input as one of the setting conditions for transition to the manual driving mode, whether or not the vehicle is driving in a safe distance free from influence from surrounding vehicles, obstacles, and the like, so that the autonomous vehicle may be safely transited to the manual driving mode.

In this regard, first, the autonomous driving controller 100 is configured to perform a control operation of adjusting the current speed of the vehicle to the driving speed set by the driver input as one of the setting conditions for transition to the manual driving mode in S109.

For example, the vehicle may be accelerated or decelerated to the driving speed set by the driver in response to a command from autonomous driving controller 100. That is, the vehicle may be accelerated by applying drive torque to the in-wheel motors 142 by the motor controller 140 or decelerated to the driving speed set by the driver by applying braking torque to the hydraulic braking devices 132 mounted on the respective wheels by the braking controller 130.

In subsequence, as an exemplary embodiment of a step of determining whether or not safe transition to manual driving mode is possible, the autonomous driving controller 100 primarily performs a step of determining whether or not the autonomous vehicle has obtained safe distances from the vehicles driving ahead and behind in the current driving lane and whether or not the autonomous vehicle is maintaining the driving speed set by the driver in S110.

For example, the autonomous driving controller 100 may receive relative distances and relative speeds of surrounding vehicles driving ahead and behind the autonomous vehicle from the autonomous driving detector, such as the camera 11, the navigation device 12, the radar 13, the LiDAR 14, and determine whether or not the autonomous vehicle is maintaining safe distances from vehicles driving ahead and behind in the current driving lane. Furthermore, the autonomous driving controller 100 may be configured to determine whether or not the current speed of the vehicle remains at the driving speed set by the driver based on a signal detected by the vehicle speed detector.

When the safe distances from the vehicles driving ahead and behind in the current driving lane are obtained and the speed of the vehicle is determined to remain at the driving speed set by the driver as the result of determination in step S110, a warning step of notifying the driver that the autonomous vehicle is in a state in which safe transition to the manual driving mode is possible is performed in S111.

For example, the autonomous driving controller may perform the warning operation of visually notifying the driver that the transition to the manual driving mode is possible using the AVN display 110 or audibly notifying the driver that the transition to the manual driving mode is possible using the audio input device 114.

In contrast, when it is determined to not be possible to maintain the safe distances from the vehicles driving ahead and behind in the current driving lane as the result of step S110, as another exemplary embodiment of the step of determining whether or not safe transition to the manual driving mode is possible, a step of determining whether or not the safe distances from the vehicles driving ahead and behind may be obtained by changing the current driving lane to another driving lane is performed in S116.

For example, the autonomous driving controller 100 may receive relative distances and relative speeds of surrounding vehicles driving ahead and behind the autonomous vehicle on other lanes in the current driving route from the autonomous driving detector, such as the camera 11, the navigation device 12, the radar 13, the LiDAR 14, and determine whether or not the autonomous vehicle may maintain the safe distances from the vehicles driving ahead and behind by changing the current driving lane to another driving lane.

Alternatively, the autonomous driving controller 100 may be configured to determine whether or not the autonomous vehicle may maintain the safe distances from the vehicles driving ahead and behind by changing the current driving lane to another driving lane based on navigation information and surrounding vehicle information provided from a control center.

Consequently, when the autonomous vehicle obtains the safe distances from the vehicles driving ahead and behind by changing the current driving lane to another driving lane as the result of the determination in step S116, the autonomous driving controller 100 performs a lane changing control to another driving lane, and when the safe distances from the vehicles driving ahead and behind are obtained and the speed of the vehicle remains at the driving speed set by the driver, performs a warning step of notifying the driver that the autonomous vehicle is in the state in which safe transition to the manual driving mode is possible in S111.

For example, as the autonomous driving controller 100 directs a steering angle signal for a lane change to the steering controller 120 and directs drive torque of the in-wheel motors 142 for movement for the lane change to the motor controller 140, the lane change from the current driving lane to another driving lane may be easily performed by steering control by the steering controller 120 and drive torque control over the in-wheel motors by the motor controller 140.

Furthermore, when the autonomous driving controller 100 determines the vehicle is parked or stopped instead of being driving as the result of the determination in step S105, the vehicle is determined to be in the state in which safe transition to the manual driving mode is possible, and the warning step of notifying the driver that safe transition to the manual driving mode is possible is performed in S111.

After the driver is notified that safe transition to the manual driving mode is possible in step S111, the autonomous driving controller 100 further configured to determine whether the driver cancels the request for transition to the manual driving mode within a predetermined time period in S112.

For example, the driver may cancel the request for transition to the manual driving mode by manipulating the corresponding menu displayed on the AVN display 110 or using the audio input device 114 within the predetermined time period.

As described above, after the driver is notified that safe transition to the manual driving mode is possible in response to the request of the driver for transition to the manual driving mode, whether or not the driver cancels the request for transition to the manual driving mode within the predetermined time period is determined to determine that the current position of the driver may be inconvenient or a time for the driver to take a position for manual driving may be insufficient.

In this regard, when the driver cancels the request for transition to the manual driving mode within the predetermined time period as the result of the determination in step S112, the autonomous driving controller 100 performs a warning operation of notifying the driver that the transition to the manual driving mode is not possible and a control operation of maintain the driving mode as the autonomous driving mode in S115.

In contrast, when the driver has not canceled the request for transition to the manual driving mode within the predetermined time period as the result of the determination in step S112, the autonomous driving controller 100 performs a control operation of transiting the driving mode to the manual driving mode in S113.

In subsequence, after the autonomous driving controller 100 transits the driving mode to the manual driving mode, when it is determined that a request to activate the operation of the SCC device is input as the setting conditions for transition to the manual driving mode after the transition to the manual driving mode, the autonomous driving controller 100 activates the operation of the SCC device 150 in S114.

Furthermore, it is determined to not be possible to obtain the safe distances from the vehicles driving ahead and behind by changing the driving lane to another driving lane in the current driving route as the result of the determination in step S116, a step of guiding the driver to select another safe position in the current driving route or a safe position in another driving route using a warning signal.

When it is determined to not be possible to set the vehicle in a safe condition (e.g., it is not possible to obtain the safe distances from the vehicles driving ahead and behind by changing the current driving lane to another driving lane) for safe transition to the manual driving mode as the result of the determination in step S116, a step of guiding the driver to select other safe positions (e.g., a side road, a service area, a rest area, etc.) in the current driving route or safe positions (e.g., a road in which the safe distances may be maintained, a service area, etc.) in other driving routes using the warning signal may be performed in S117.

For example, in response to an instruction of the autonomous driving controller 100 based on navigation recommended information and route information provided by the control center, other safe positions (e.g., a side road, a service area, a rest area, etc.) in the current driving route or safe positions (e.g., a road in which the safe distances may be maintained, a service area, etc.) in other driving routes may be guided and displayed on the navigation device 12 to be selected by the driver.

In subsequence, whether or not the driver selects one of the other safe positions in the current driving route or the safe positions in other driving routes is determined in S118.

For example, the driver may selectively input one of the other safe positions in the current driving route or the safe positions in other driving routes displayed on the navigation device 12.

When the driver has not selected one of the other safe positions in the current driving route or the safe positions in other driving routes for a predetermined time period as the result of the determination in step S118, the autonomous driving controller 100 performs a warning operation of notifying the driver that the transition to the manual driving mode is not possible and a control operation of maintaining the driving mode as the autonomous driving mode in S115.

In contrast, when the driver has selected one of the other safe positions in the current driving route or the safe positions in other driving routes for a predetermined time period as the result of the determination in step S118, a control operation of moving the vehicle to the selected position is performed in S119.

For example, as the autonomous driving controller 100 performs the autonomous driving mode to the safe position selected as a target the autonomous vehicle may move to the safe position selected as the target.

Accordingly, after the autonomous vehicle has moved to the safe position selected as the target, the autonomous driving controller 100 repeats the above-described control operations for safe transition to manual driving mode, including steps S105 to S119.

As set forth above, when there is a request of a driver for transition to manual driving mode, the autonomous vehicle may be set to a safe state with no risk of colliding with surrounding vehicles by performing control operations of maintaining a vehicle speed previously designated by the driver, maintaining safe distances between vehicles, and changing the driving land and the driving route, so that the request of the driver for transition to manual driving mode may be safely performed in a state in which the safety of the autonomous vehicle is obtained.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A control method for safe transition to a manual driving mode in a vehicle, the control method comprising:
setting, by a controller, setting conditions for transition to the manual driving mode;
determining, by the controller, whether there is a request of a driver for the transition to the manual driving mode;
determining, by the controller, whether the vehicle is driving and whether the vehicle is driving straight, when the controller concludes that there is the request of the driver for the transition to the manual driving mode;
controlling, by the controller, a current speed of the vehicle at a driving speed set by the driver which is one of the setting conditions for the transition to the manual driving mode, when the vehicle is driving straight;
determining, by the controller, whether the vehicle is in a state in which the safe transition to the manual driving mode is possible;
notifying, by the controller, that the vehicle is in the state in which the safe transition to the manual driving mode is possible; and
switching, by the controller, a driving mode of the vehicle to the manual driving mode, after the notification is performed for a first predetermined time period.

2. The control method of claim 1, wherein the setting conditions for the transition to the manual driving mode include the driving speed set by the driver of the vehicle, and whether to activate a smart cruise control device after having switched to the manual driving mode.

3. The control method of claim 1, further including:
determining, by the controller, whether the setting conditions for the transition to the manual driving mode are changed before the request for the transition to the manual driving mode is made.

4. The control method of claim 1, further including:
when the vehicle is determined to be turning as a result of the determining of whether the vehicle is driving straight, determining, by the controller, whether the vehicle is able to drive straight within a second predetermined time period.

5. The control method of claim 4, further including:
when the vehicle is determined to not be able to drive straight within the second predetermined time period, notifying, by the controller, the driver that the transition to the manual driving mode is not possible and maintaining the driving mode as an autonomous driving mode of the vehicle.

6. The control method of claim 1, wherein, in the determining of whether the vehicle is in the state in which the safe transition to the manual driving mode is possible, determining, by the controller, whether the vehicle has obtained safe distances from vehicles driving ahead and behind the vehicle and whether the driving speed set by the driver is maintained is performed first.

7. The control method of claim 6, wherein, when the vehicle is determined to have obtained the safe distances from the vehicles driving ahead and behind the vehicle and the driving speed set by the driver is determined to be maintained, the driver is notified by the controller that the vehicle is in the state in which the safe transition to the manual driving mode is possible.

8. The control method of claim 6, wherein, when the vehicle is determined to not be able to obtain the safe distances from the vehicles driving ahead and behind the vehicle, the determining of whether the vehicle is in the state in which the safe transition to the manual driving mode is possible includes determining whether the vehicle is able to obtain the safe distances from the vehicles driving ahead and behind the vehicle by changing a current driving lane of the vehicle to another driving lane.

9. The control method of claim 8, wherein, when the vehicle is determined to be able to obtain the safe distances from vehicles driving ahead and behind the vehicle by changing the current driving lane to another driving lane, the driver is notified that the vehicle is in the state in which the safe transition to the manual driving mode is possible.

10. The control method of claim 1, wherein, when the vehicle is determined to be being parked or stopped instead of being driving as a result of the determining of whether the vehicle is driving, the vehicle is determined by the controller to be in the state in which the safe transition to the manual driving mode is possible, and the driver is notified by the controller that the vehicle is in the state in which the safe transition to the manual driving mode is possible.

11. The control method of claim 1, further including:
after notifying that the vehicle is in the state in which the safe transition to the manual driving mode is possible, determining, by the controller, whether the driver has canceled the request for the transition to the manual driving mode within a third predetermined time period.

12. The control method of claim 11, further including:
when the driver has canceled the request for the transition to the manual driving mode within the third predetermined time period, notifying, by the controller, the driver that the transition to the manual driving mode is not possible and maintaining the driving mode of the vehicle as an autonomous driving mode of the vehicle.

13. The control method of claim 11, wherein, when the driver has not canceled the request for the transition to the manual driving mode within the third predetermined time period, the transition of the driving mode of the vehicle to the manual driving mode is performed by the controller.

14. The control method of claim 1, further including:
when the controller concludes that a request to activate an operation of a smart cruise control device has been input as the setting conditions for the transition to the manual driving mode after the transition of the driving mode of the vehicle to the manual driving mode by the controller, activating, by the controller, the operation of the smart cruise control device.

15. The control method of claim 8, further including:
when the controller concludes that the vehicle cannot obtain the safe distances from the vehicles driving ahead and behind the vehicle by changing the current driving lane to another driving lane, guiding, by the controller, the driver to select another safe position in the current driving route of the vehicle or a safe position in another driving route using a warning signal.

16. The control method of claim 15, further including:
when the driver has not selected another safe position in the current driving route or the safe position in another driving route, notifying, by the controller, the driver that the transition to the manual driving mode is not possible and maintaining the driving mode of the vehicle as an autonomous driving mode of the vehicle.

17. The control method of claim 15, further including:
when the driver has selected another safe position in the current driving route or another safe position in another driving route, controlling, by the controller, the vehicle to move to the position selected by the driver.

18. The control method of claim 17, further including:
after the vehicle has moved to the selected position, returning to the determining of whether the vehicle is driving and whether the vehicle is driving straight by the controller.

19. A non-transitory computer readable storage medium on which a program for performing the method of claim 1 is recorded.
